(19) United States
(12) Patent Application Publication
(10) Pub. No.: US 2014/0151528 A1
(43) Pub. Date: Jun. 5, 2014

(54) DYNAMIC DAMPER FOR VEHICLE

(71) Applicant: HYUNDAI MOTOR COMPANY, Seoul (KR)

(72) Inventor: Yong-Bin Park, Bucheon (KR)

(73) Assignee: HYUNDAI MOTOR COMPANY, Seoul (KR)

(21) Appl. No.: 13/886,513

(22) Filed: May 3, 2013

(30) Foreign Application Priority Data
Dec. 5, 2012 (KR) 10-2012-0140490

(51) Int. Cl. F16F 3/093; F16F 15/08; F16M 13/02

(52) U.S. Cl. CPC F16F 3/093; F16M 13/02; F16F 15/08
USPC 248/634; 267/141; 267/140.5

(57) ABSTRACT

A dynamic damper mounted within a vehicle is capable of tuning a resonance frequency for each direction and includes a housing formed by a vertical plate connected to a bottom plate. A first rubber having elasticity is seated on the bottom plate and a mass is seated on the first rubber in a vertical direction and is spaced apart from the vertical plate. A second rubber having elasticity is mounted between the mass and the vertical plate.

### CROSS-REFERENCE TO RELATED APPLICATIONS

This application claims priority under 35 U.S.C. §119 to Korean Patent Application No. 10-2012-0140490, filed on Dec. 5, 2012, in the Korean Intellectual Property Office, the disclosure of which is incorporated herein by reference in its entirety.

### BACKGROUND

1. Field of the Invention

The present invention relates to a dynamic damper for a vehicle, and more particularly, to a dynamic damper for a vehicle having a plurality of rubbers to remove a resonance of horizontal vibrations (x-axis and y-axis vibrations) and a vertical vibration (a z-axis vibration).

2. Description of the Related Art

A dynamic damper refers to an apparatus configured to suppress a resonance occurring at a structure and is widely used in various fields. The dynamic damper is mounted within a vehicle, and an aspect of a dynamic damper for a vehicle of the related art is illustrated in FIG. 1A.

As illustrated in FIG. 1A, a dynamic damper for a vehicle (e.g., a dynamic damper mounted in the vicinity of an engine mount and a transmission mount) has a structure in which a rubber 2 made of a rubber material (or a synthetic resin material) is attached on a circular disc shaped plate 3 mounted to a structure where a vibration is generated, and a mass 1 having a predetermined weight is seated on the rubber 2.

As illustrated in FIG. 1B, as the dynamic damper is mounted within the vehicle, a resonance frequency may be tuned to reduce an amplitude and a peak of the resonance frequency in a pattern from state (a) before mounting the dynamic damper to state (b) after mounting the dynamic damper.

Moreover, when a structure such as a vehicle, in which a vibration is transmitted by various vibration excitation sources and through various paths, a system for isolating the vibration has various frequency properties. In other words, the resonance of a structure may occur in multiple axes directions based on a condition for driving a vehicle, a state of a road surface, or the like.

When the resonance occurs only in a vertical direction (e.g., a z-axis direction) as shown in FIG. 1A, the resonance frequency may be tuned by adjusting hardness or thickness of the rubber 2 that is an elastic body. However, when the resonance occurs in a horizontal direction and a vertical direction (e.g., x-axis and y-axis directions), the tuning of the frequency may not be easily performed by the existing structure of the dynamic damper. In other words, the existing dynamic damper has a structure in which only the single rubber 2 is integrally formed by an injection molding method (or a vulcanization method) between the plate 3 and the mass 1 for configuring a secondary mass system.

Therefore, when the dynamic damper is tuned in advance according to a z-axis resonance frequency, it may not be possible to tune the frequencies in x-axis and y-axis directions to desired frequency bands. Further, in the dynamic damper having a structure of the related art, since the setting of frequencies is the same in the x-axis and the y-axis, it may not be possible to tune the frequency for each direction.

### SUMMARY

The present invention provides a dynamic damper for a vehicle capable of tuning frequencies in x-axis and y-axis directions and a frequency in a z-axis direction.

An exemplary embodiment of the present invention provides a dynamic damper mounted within a vehicle, including: a housing formed by a vertical plate connected to a bottom plate; a first rubber manufactured with a material having elasticity and seated on the bottom plate; a mass seated on the first rubber in a vertical direction and spaced apart from the vertical plate; and a second rubber manufactured with a material having elasticity and mounted between the mass and the vertical plate.

The first rubber and the second rubber may be manufactured with materials having different elastic properties, and a third rubber having an elastic property different from that of the second rubber may be mounted between the mass and the vertical plate. Further, the mass may have a cylindrical shape, and the vertical plate may be formed in a pipe shape to allow the mass to be fitted within the vertical plate. In addition, the mass may have a cylindrical shape, and a horizontal cross section of the vertical plate may be formed in a partially cut pipe shape having a semicircular shape or a “C” shape to expose a lateral surface of the mass.

In the dynamic damper for a vehicle according to the exemplary embodiment of the present invention, which is configured as described above, a tuning of a resonance frequency for each direction may be performed, and damping performance and durability performance of the dynamic damper may be improved by mounting a plurality of rubbers.

### BRIEF DESCRIPTION OF THE DRAWINGS

FIG. 1A is an exemplary view of a dynamic damper for a vehicle according to the related art;

FIG. 1B is a plurality of exemplary graphs illustrating a change in resonance frequency based on the installation of a dynamic damper according to the related art;

FIG. 2 is an exemplary view of a dynamic damper according to an exemplary embodiment of the present invention;

FIG. 3 is an exemplary view illustrating an aspect in which the dynamic damper illustrated in FIG. 2 is partially cut to show an inner structure according to an exemplary embodiment of the present invention;

FIG. 4 is an exemplary view of a dynamic damper and a housing according to an exemplary embodiment; and

FIG. 5 is an exemplary view illustrating an aspect (i) in which a dynamic damper according to an exemplary embodiment of the present invention is attached to an engine support bracket, and an aspect (ii) in which the dynamic damper is attached to a transmission mount according to an exemplary embodiment of the present invention.

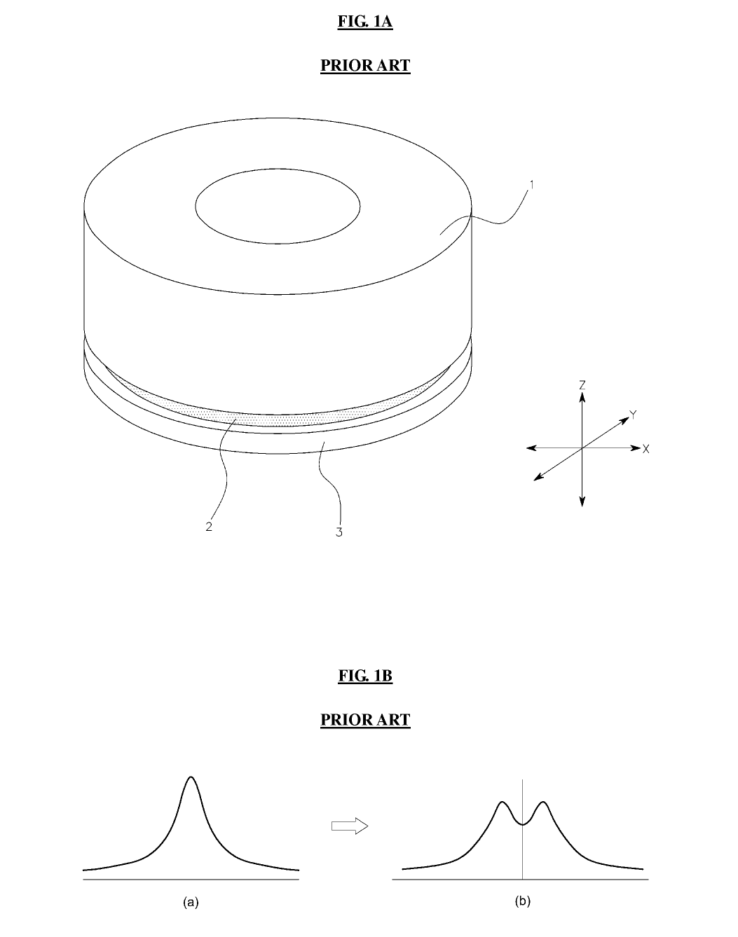

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

A dynamic damper for a vehicle according to an exemplary embodiment of the present invention may be mounted at an apparatus, which may transmit a vibration to a vehicle body, such as an engine support bracket mounted at the vehicle body to support an engine mount, and a sub frame disposed at a lower portion of a power train, and the engine mount or a transmission mount. The dynamic damper may be configured to suppress a resonance phenomenon and improve a noise characteristic, and to suppress a vibration in a single axis direction (e.g., a z-axis direction) and efficiently suppress vibrations in multiple axes directions (e.g., x-axis and y-axis directions).

Hereinafter, the dynamic damper for a vehicle according to an exemplary embodiment of the present invention will be described in more detail with reference to the drawings.

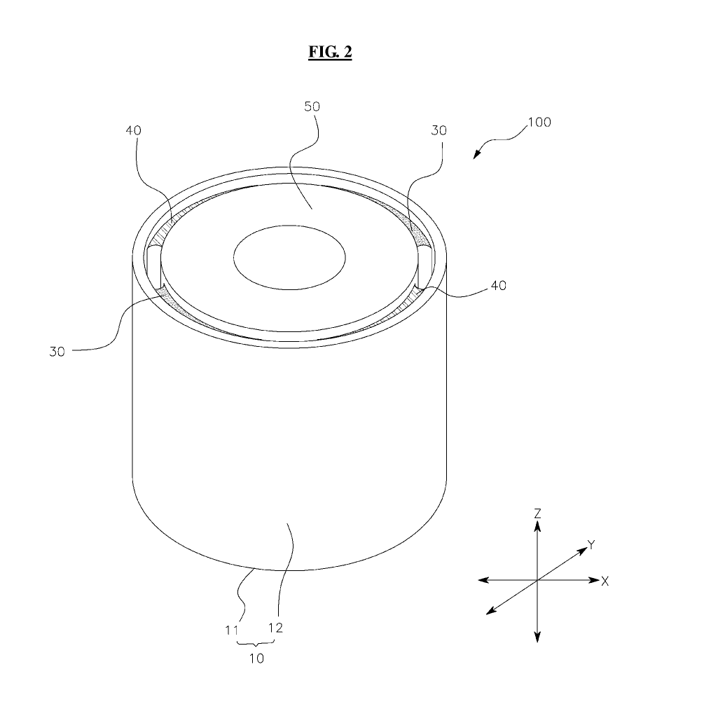

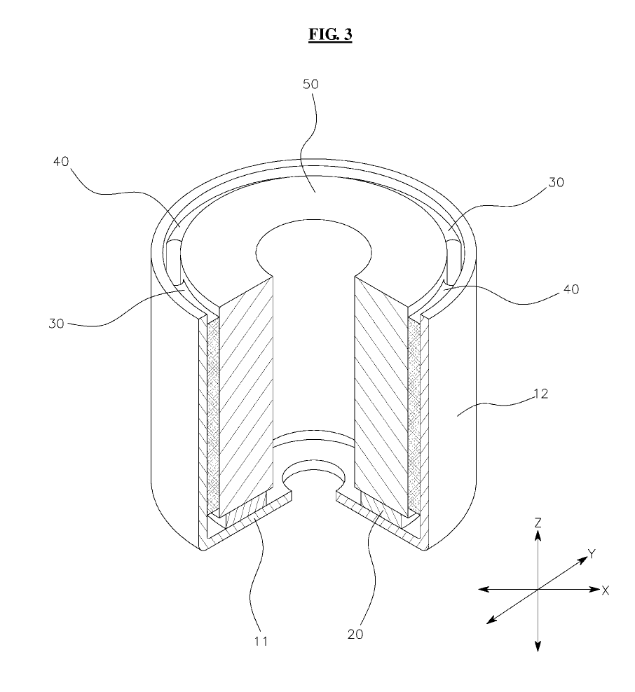

Referring to FIGS. 2 and 3, a dynamic damper for a vehicle according to an exemplary embodiment of the present invention may include a housing 10 having a cup shape (e.g., a shape of a case or a container of which an upper side is opened, such as a cylindrical shape). In other words, the housing 10 may have a shape in which a vertical plate 12 having a pipe shape is connected in a vertical direction along a circumference of an edge portion of a circular disc shaped bottom plate 11.

A first rubber 20 manufactured with a synthetic rubber material (or a synthetic resin material) to have a predetermined elasticity and a mass 50 seated vertically on the first rubber 20 may be seated on an upper side of the bottom plate 11. The mass 50 may be manufactured with a metallic material having a predetermined weight, and may have a diameter to form a gap with the vertical plate 12.

One or more second rubbers 30 may be mounted within the gap formed between the mass 50 and the vertical plate 12, and one or more third rubbers 40 may be mounted between the gap formed between the mass 50 and the vertical plate 12. The second rubber 30 and the third rubber 40 may be manufactured with a material having elasticity, and materials having different material properties and elasticity properties from each other may be selectively adapted to the first rubber 20, the second rubber 30, and the third rubber 40, respectively. The first rubber 20 may be tuned corresponding to a resonance frequency relevant to a z-axis direction vibration of the dynamic damper, and the second rubber 30 and the third rubber 40 may be tuned corresponding to resonance frequencies relevant to x-axis and y-axis direction vibrations of the dynamic damper.

Moreover, in the present invention, the mass 50 may be formed in various shapes including a cylindrical shape and a polygonal column shape, and the housing 10 may have a shape such as a pipe shape or a hexahedron shape based on the shape of the mass 50.

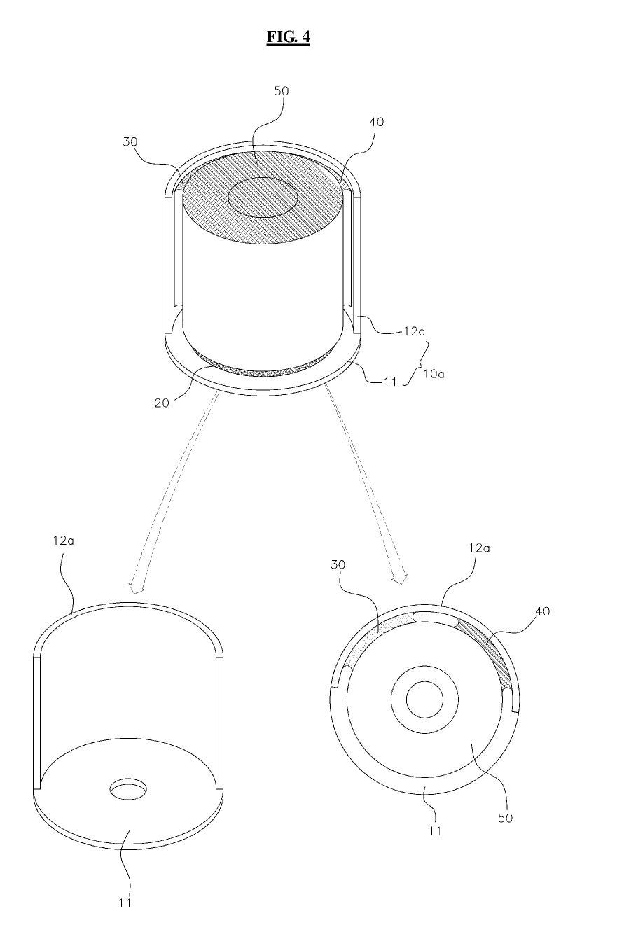

As illustrated in FIG. 4, a horizontal cross section of a vertical plate 12a of a housing 10a according to another exemplary embodiment of the present invention may be formed to have a semicircular shape or a “C” shape to allow a part of a lateral surface of the mass 50 to be exposed, and the numbers and the sizes of the second rubber 30 and the third rubber 40 may also be adjusted.

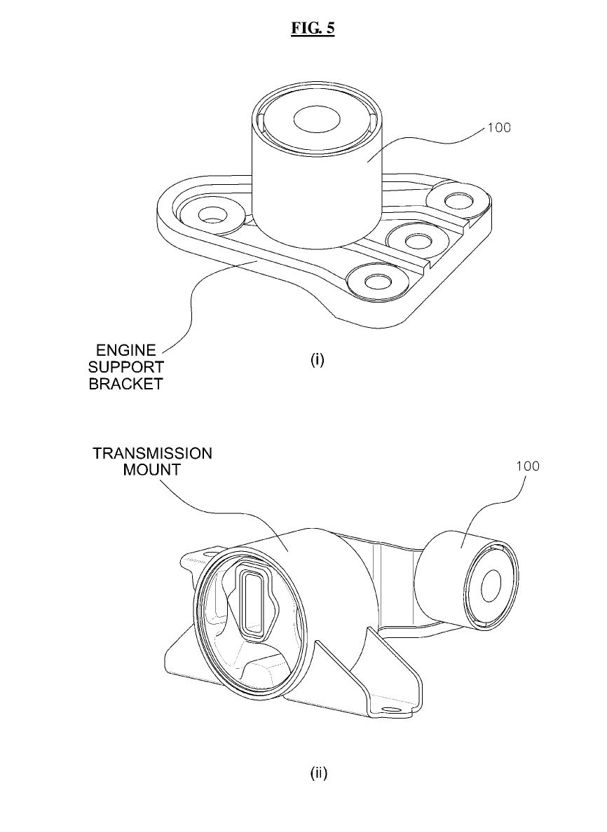

A dynamic damper 100 for a vehicle according to the exemplary embodiment of the present invention, which is configured as described above, may be mounted at an engine support bracket, a transmission mount, or the like to which the vibration is transmitted to dampen the resonance frequency, as illustrated in FIG. 5. In addition, a tuning of the resonance frequency for each direction may be performed. In other words, the tuning of the frequency for each direction may be performed by changing hardness values of the first rubber 20, the second rubber 30, and the third rubber 40, which are disposed in each direction.

Furthermore, the materials of the first rubber 20, the second rubber 30, and the third rubber 40 may be configured to be different for each direction based on a mount position and required performance. When the first rubber 20, the second rubber 30, and the third rubber 40 are manufactured by a multiple injection molding method, and since different rubber materials may be used for the first rubber 20, the second rubber 30, and the third rubber 40, an NR (natural rubber) material having an advantage of not being sensitive to a temperature variation, an IIR (isobutene-isoprene rubber) material sensitive to the temperature variation but able to obtain a high damping value, and an EPDM (ethylene propylene diene monomer) material having an substantially high heat resistant performance may be applied by being mixed for each direction based on the required performance.

Further, the durability of the dynamic damper may be improved. In particular, when examining a vibration property in z-axis direction as an example, in the structure of the related art, the rubber 2 operates as a compression spring. However, when one of the first rubber 20, the second rubber 30, and the third rubber 40 according to the exemplary embodiment of the present invention is compressed, the other rubbers may be relatively and elastically restored, and thus vibration excitation force may be distributed, to obtain a higher damping value compared to the structure of the related art, and a damping effect may be obtained in a wider frequency range, thereby improving damping performance and durability of the dynamic damper.

In addition, in the present invention, heat resistant performance of the dynamic damper may be improved. In particular, at a high temperature state, a property value of the rubber having elasticity may change due to heat, aging may be rapidly progressed, and performance may deteriorate. However, in the present invention, the vertical plate 12 operates as a heat protector and protects the first rubber 20, the second rubber 30, and the third rubber 40 from a heat source, thus improving heat resistant performance of the dynamic damper.

Additionally, in the dynamic damper of the related art, the mass 1 may be moved away from the plate 3 when crack or damage is generated at the rubber 2. However, in the present invention, since the first rubber 20, the second rubber 30, and the third rubber 40 fix the mass 50 to the housing 10, the mass 50 may be prevented from being moved away from the plate when one of the first rubber 20, the second rubber 30, and the third rubber 40 is damaged.

The exemplary embodiments disclosed in the present specification and the drawings are only examples for easy understanding of the present invention, and the present invention is not limited thereto. Here, it is obvious to a person skilled in the art that besides the exemplary embodiments disclosed herein, various modifications can be made based on the technical spirit of the present invention.

What is claimed is:

1. A dynamic damper mounted within a vehicle, the dynamic damper comprising:
a housing formed by a vertical plate connected to a bottom plate;
a first rubber seated on the bottom plate;
a mass seated on the first rubber in a vertical direction and spaced apart from the vertical plate; and
a second rubber mounted between the mass and the vertical plate.

2. The dynamic damper of claim 1, wherein the first rubber and the second rubber are manufactured with materials having different elastic properties.

3. The dynamic damper of claim 1, further comprising:
a third rubber having an elastic property different from that of the second rubber, wherein the third rubber is interdisposed between the mass and the vertical plate.

4. The dynamic damper of claim 3, wherein the mass and the vertical plate are cylindrical.

5. The dynamic damper of claim 3, wherein the mass has a cylindrical shape, and a horizontal cross section of the vertical plate is formed in a semicircular shape or a “C” shape to expose a lateral surface of the mass.

6. The dynamic damper of claim 1, wherein the dynamic damper is mounted to an engine support bracket or a transmission mount.

7. A damper, comprising:
a cylindrical housing with one closed end, one open end, and a vertical wall;
a first rubber seated on an inner surface of the closed end of the cylindrical housing;
a mass seated on a top of the first rubber; and
a second rubber interdisposed between at least a portion of the mass and the vertical plate.

8. The damper of claim 7, wherein the first rubber and the second rubber are manufactured with materials having different elastic properties.

9. The damper of claim 7, further comprising:
a third rubber having an elastic property different from that of the second rubber, wherein the third rubber is interdisposed between the mass and the vertical plate at a different portion than the second rubber.

10. The damper of claim 7, wherein the mass is cylindrical.

11. The damper of claim 7, wherein the damper is mounted to an engine support bracket or a transmission mount.
